(19) United States
(12) Patent Application Publication
(10) Pub. No.: US 2025/0137464 A1
(43) Pub. Date: May 1, 2025

(54) COMPRESSOR ASSEMBLY WITH A SILENCER

(71) Applicant: Dyson Technology Limited, Malmesbury, Wiltshire (GB)

(72) Inventors: Wei Ping LIONG, Kulai, Johor (MY); Kee Kung CHEN, Johor Bahru (MY)

(21) Appl. No.: 18/835,422

(22) PCT Filed: Feb. 9, 2023
(86) PCT No.: PCT/GB2023/050292

§ 371 Date: Aug. 2, 2024

(30) Foreign Application Priority Data
Feb. 11, 2022 (GB) 2201763.6

(51) Int. Cl. F04D 29/52; A47L 5/24; A47L 9/00; F04D 29/66

(52) U.S. Cl. CPC F04D 29/522; A47L 9/0081; F04D 29/664; F04D 29/665; A47L 5/24; F05D 2250/52; F05D 2260/96

(57) ABSTRACT

A compressor assembly is described comprising a compressor for generating an airflow through the compressor assembly and a silencer located downstream of the compressor. The silencer comprises a plurality of holes through which a portion of the airflow flows, a first end proximal to the compressor, a second end distal to the compressor, and serrations provided at one of the first end and the second end and between which a further portion of the airflow flows.

### FIELD OF THE INVENTION

The present invention relates to a compressor assembly.

### BACKGROUND OF THE INVENTION

Some compressor assemblies may employ a compressor to generate an airflow. The compressor can, however, be a significant source of noise.

### SUMMARY OF THE INVENTION

The present invention provides a compressor assembly comprising a compressor for generating an airflow through the compressor assembly, a silencer located downstream of the compressor, the silencer comprising a plurality of holes through which a portion of the airflow flows, a first end proximal to the compressor, a second end distal to the compressor, and serrations provided at one of the first end and the second end and between which a further portion of the airflow flows. As a result, the noise generated by the compressor may be reduced whilst also achieving a relatively small reduction in the flow rate for the airflow (for example, when compared to utilising dense acoustic foam). Specifically, the holes of the silencer may break down large eddies in the airflow, which may reduce large scale turbulence and thereby reduce the generated noise. Additionally, the inventors have observed that the serrations generate streamwise vorticity in the airflow, which provides more mixing at the free shear layer and thereby reduces the noise generated whilst also providing only a relatively small reduction in the airflow flow rate. Reducing the noise generated by the compressor may have several benefits, including improving the acoustic experience of a user of the compressor and aiding in compliance with noise limit regulations. Moreover, in applications where a filter is located downstream of the compressor, noise reduction may be achieved without modification to the filter. For example, modifying the filter to incorporate dense acoustic foam. Thereby, the performance of the filter (e.g. washability and filter life) may not be impacted whilst also achieving reduced noise generation.

Each serration may have a height of no less than 2 mm. As the height of the serrations decreases, more of the airflow is forced through the holes of the silencer, thereby reducing the contribution of the serrations to the noise reduction. At heights below 2 mm, a relatively modest reduction in noise may therefore be observed.

Each serration may have a height of no greater than 10 mm. As the height of the serrations increases, the size of the compressor assembly also increases. Additionally, the inventors have observed that the gains in noise reduction are more modest at heights greater than 10 mm. I.e., for heights greater than 10 mm, the reduction in noise for a given increase in height is small. Thereby, by having a height of no greater than 10 mm, a more compact arrangement for the compressor assembly may be achieved. A more compact arrangement may be beneficial in applications for which space is a premium. For example, handheld devices (such as a handheld vacuum cleaner) where a more compact arrangement may improve the ergonomics of the device. Furthermore, serrations having a height of at least 2 mm and no greater than 10 mm may provide a good balance between the competing needs of reducing the noise generated and providing a compact compressor assembly.

Each hole may be polygonal in shape. For example, each hole may be hexagonal, square or triangular in shape. The inventors have observed that holes with straight edges aid in reducing the noise generated. As a result, the noise generated may be reduced without reducing the flow rate of the airflow as the shape of the holes may be changed without reducing the area of the holes (and thereby increasing the restriction to the airflow presented by the holes). Each hole may be hexagonal in shape. This then has the benefit that holes of a given area, and having distinct straight edges, may be achieved in a relatively compact arrangement.

Each hole may have an area of no greater than 7 mm². As the areas of the holes increases, the silencer presents a smaller restriction to the airflow, and therefore a smaller reduction in the flow rate of the airflow may be observed. However, as the areas of the holes increases, the amount of noise reduction provided by the silencer is likely to decrease. Therefore, by having an area of no greater than 7 mm², a good level of noise reduction may be achieved.

Each hole may have an area of no less than 1.5 mm². As the areas of the holes decreases, a greater reduction in noise may be observed. However, the restriction presented by the silencer is likely to increase, resulting in a greater reduction in the flow rate of the airflow. Having an area of no less than 1.5 mm² may therefore result in good noise reduction without adversely reducing the flow rate of the airflow. Furthermore, each hole may have an area of no greater than 7 mm² and no less than 1.5 mm². This range may provide a good balance between the competing needs of reducing noise and achieving a good flow rate.

The compressor assembly may comprise an enclosure for enclosing the silencer. The enclosure may comprise a plurality of holes through which the airflow passes. The enclosure may thereby act as a second silencer for further reducing the noise generated. Each hole of the silencer may be aligned with a respective hole of the enclosure. The overall restriction of the airflow by the holes may therefore be reduced (for example, compared to holes which are not aligned), which may reduce the reduction in flow rate caused by the holes of the enclosure and/or silencer.

A ratio of an area of each hole of the silencer to an area of the respective hole of the enclosure may be less than 1.0. The inventors have observed that as the ratio is reduced below 1.0, the noise generated decreases significantly. By having a ratio of less than 1.0, and more particularly less than 0.6, the noise generated may thereby be reduced.

The ratio may be no less than 0.2. As a result, the area of each hole of the silencer may be sufficiently large for a good flow rate to be achieved, whilst also achieving a sufficiently small area for each hole of the enclosure to reduce the noise generated. Moreover, by having a ratio of between 1.0 and 0.2, and more particularly 0.6 and 0.2, a good balance may be achieved between the competing needs to reduce the noise generated and achieve a good airflow flow rate.

The compressor assembly may comprise an acoustic foam located downstream of the compressor and upstream of the silencer. By comprising an acoustic foam, the noise generated may be further reduced. Additionally, by locating the acoustic foam upstream of the silencer, a relatively compact arrangement may be achieved.

The silencer may surround the acoustic foam. The acoustic foam may therefore be regarded as nested within the silencer, which may provide a more compact arrangement.

The airflow may be emitted from the compressor in an axial direction. The silencer may be cylindrical in shape, and the airflow may pass through the holes of the silencer and between the serrations in a radial direction. As a result, a relatively short and compact silencer may be employed that nevertheless has sufficient open area to deliver a desired flow rate.

The silencer may be mounted to the compressor at the first end, and the serrations may be provided at the second end. This may reduce the noise generated by reducing the vibrations transferred from the compressor to the serrations which may generate additional structural vibrational noise. Additionally, by mounting the compressor at the first end (as compared to mounting the compressor at the second end with the serrations) stress concentrations at the ends of the serrations may be reduced, which may increase the operational life of the compressor assembly.

The present invention also provides a silencer for a compressor comprising a cylindrical body having a plurality of holes through which a portion of an airflow generated by the compressor flows, and serrations provided at an end of the cylindrical body and between which a further portion of the airflow flows. As discussed previously, the silencer may thereby reduce noise generated by the compressor whilst also achieving a relatively small reduction in the flow rate for the airflow. Specifically, the holes of the silencer may break down large eddies in the airflow, which may reduce large scale turbulence and thereby reduce the generated noise. Additionally, the inventors have observed that the serrations generate streamwise vorticity in the airflow, which provides more mixing at the free shear layer and thereby reduces the noise generated whilst also providing only a relatively small reduction in the airflow flow rate. By having a cylindrical shape, a good open area for the holes and the serrations may be achieved whilst also achieving a compact arrangement for the silencer.

The present invention also provides a compressor assembly comprising a compressor for generating an airflow through the compressor assembly, a silencer located downstream of the compressor, the silencer comprising a plurality of holes through which at least a portion of the airflow flows, and an enclosure located downstream of the silencer, the enclosure comprising a plurality of holes through which the airflow flows, wherein each hole of the silencer is aligned with a respective hole of the enclosure, and a ratio of an area of each hole of the silencer to an area of the respective hole of the enclosure is less than 1.0. As previously discussed, the noise generated by the compressor may thereby be reduced whilst also achieving a relatively small reduction in the flow rate for the airflow. Specifically, the holes of the silencer may break down large eddies in the airflow, which may reduce large scale turbulence and thereby reduce the generated noise. Additionally, the enclosure may act as a second silencer for further reducing the noise generated. By aligning the holes, the overall restriction of the airflow by the holes may be reduced (for example, compared to holes which are not aligned), which may reduce the reduction in flow rate caused by the holes of the enclosure and/or silencer. The inventors have observed that as the ratio is reduced below 1.0, the noise generated decreases significantly. By having a ratio of less than 1.0, and more particularly less than 0.6, the noise generated may thereby be reduced.

The ratio may be no less than 0.2. As a result, the area of each hole of the silencer may be sufficiently large for a good flow rate to be achieved, whilst also achieving a sufficiently small area for each hole of the enclosure to reduce the noise generated. Moreover, by having a ratio of between 1.0 and 0.2, and more particularly 0.6 and 0.2, a good balance may be achieved between the competing needs to reduce the noise generated and achieve a good airflow flow rate.

The holes of the silencer may have a different shape to the holes of the enclosure. With differently shaped holes, it is possible that the noise generated may be further reduced. More specifically, the holes of the silencer may be polygonal in shape, and the holes of the enclosure may be circular or elliptical in shape. As discussed previously, the inventors have observed that holes with straight edges aid in reducing the noise generated. As a result, the noise generated may be reduced without reducing the flow rate of the airflow as the shape of the holes may be changed without reducing the area of the holes (and thereby increasing the restriction to the airflow presented by the holes).

The silencer may comprise a first end proximal to the compressor, a second end distal to the compressor, and serrations provided at one of the first end and the second end and between which a further portion of the airflow flows. As discussed previously, the inventors have observed that the serrations generate streamwise vorticity in the airflow, which provides more mixing at the free shear layer and thereby reduces the noise generated whilst also providing only a relatively small reduction in the airflow flow rate. Providing serrations therefore may result in a reduction in the noise generated whilst also providing a good airflow flow rate.

Each serration may have a height of no less than 2 mm. As the height of the serrations decreases, more of the airflow is forced through the holes of the silencer, thereby reducing the contribution of the serrations to the noise reduction. At heights below 2 mm, a relatively modest reduction in noise was observed for this particular silencer.

Each serration may have a height of no greater than 10 mm. As the height of the serrations increases, the size of the compressor assembly also increases. Additionally, the inventors have observed that the gains in noise reduction are more modest at heights greater than 10 mm. I.e., for heights greater than 10 mm, the reduction in noise for a given increase in height is small. Thereby, by having a height of no greater than 10 mm, a more compact arrangement for the compressor assembly may be achieved. A more compact arrangement may be beneficial in applications for which space is a premium. For example, handheld devices (such as a handheld vacuum cleaner) where a more compact arrangement may improve the ergonomics of the device.

The compressor assembly may comprise an acoustic foam located downstream of the compressor and upstream of the silencer. By comprising an acoustic foam, the noise generated may be further reduced. Additionally, by locating the acoustic foam upstream of the silencer, a relatively compact arrangement may be achieved.

The silencer may surround the acoustic foam. The acoustic foam may therefore be regarded as nested within the silencer, which may provide a more compact arrangement.

The airflow may be emitted from the compressor in an axial direction. The silencer may be cylindrical in shape, and the airflow may pass through the holes of the silencer in a radial direction. The airflow may pass between the serrations in a radial direction. As a result, a relatively short and compact silencer may be employed that nevertheless has sufficient open area to deliver a desired flow rate.

The silencer may be mounted to the compressor at the first end, and the serrations may be provided at the second end. This may reduce the noise generated by reducing the vibrations transferred from the compressor to the serrations which may generate additional structural vibrational noise. Additionally, by mounting the compressor at the first end (as compared to mounting the compressor at the second end with the serrations) stress concentrations at the ends of the serrations may be reduced, which may increase the operational life of the compressor assembly.

The present invention also provides a vacuum cleaner comprising the compressor assembly or silencer.

### BRIEF DESCRIPTION OF THE DRAWINGS

FIG. 1 is a side view of a vacuum cleaner;

FIG. 2 is a side view of part of the vacuum cleaner in which a filter assembly of the vacuum cleaner has been removed;

FIG. 3 is a side view of a compressor assembly of the vacuum cleaner;

FIG. 4 is a simplified schematic of a section through a centre of the compressor assembly; and

FIG. 5 is a perspective view of a silencer of the compressor assembly.

### DETAILED DESCRIPTION OF THE INVENTION

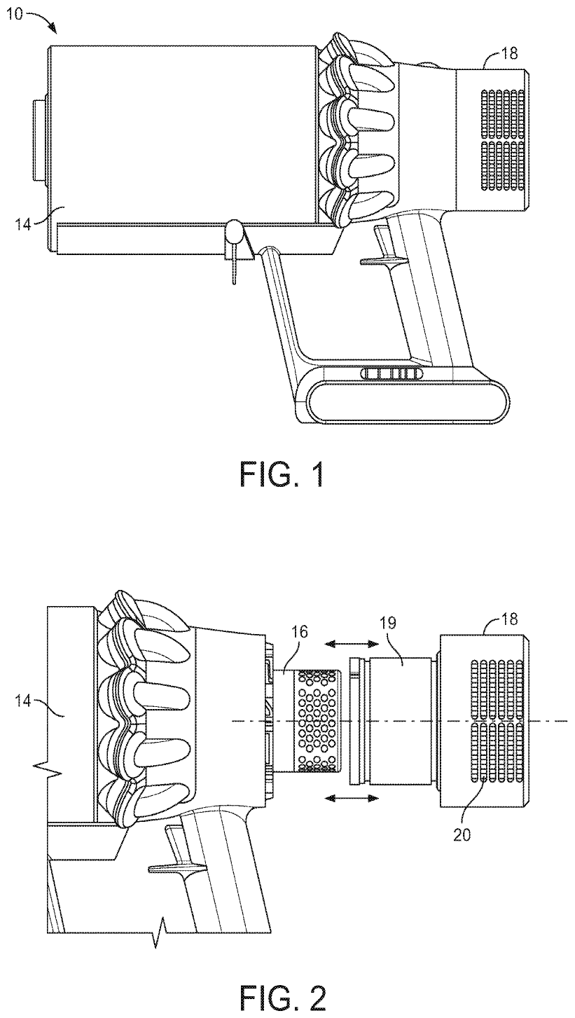

The vacuum cleaner 10 of FIGS. 1 and 2 is of a handheld type and comprises a separation system 14, a compressor assembly 16, and a filter assembly 18.

The compressor assembly 16 and the filter assembly 18 are located downstream of the separation system 14. The filter assembly 18 surrounds the compressor assembly 16 and comprises a pre filter 19 and a post filter 20. The pre filter 19 is located upstream of the compressor assembly 16, and the post filter 20 is located downstream of the compressor assembly 16.

During use an airflow is drawn by the compressor assembly 16 into the vacuum cleaner 10. The airflow passes through the separation system 14 where dust entrained in the airflow is separated from the airflow. The airflow then passes through the pre filter 19, which removes further dust from the airflow. Then the airflow passes through the compressor assembly 16, before passing through the post filter 20 and exiting the vacuum cleaner 10.

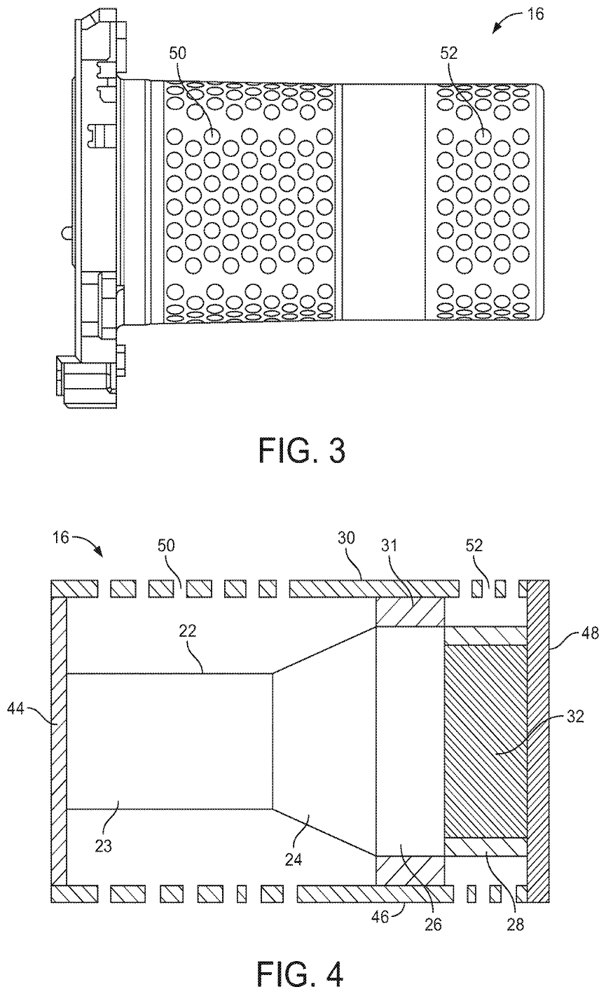

Turning to FIGS. 3 to 5, the compressor assembly 16 comprises a compressor 22, a silencer 28, an enclosure 30, a seal 31 and an acoustic foam 32.

The compressor 22 generates the airflow and comprises an electric motor 23, an impeller 24 and a diffuser 26. The electric motor 23 drives the impeller 24 to generate the airflow. The diffuser 26 is located downstream of the impeller 24 and converts kinetic energy of the airflow exiting the impeller 24 into static pressure. The airflow is emitted from the compressor 22 in an axial direction, i.e., in a direction parallel to the axis of rotation of the compressor 22.

The silencer 28 is mounted to, and is located downstream of, the compressor 22. More particularly, the silencer 28 is mounted to an end of the compressor 22. The silencer 28 comprises a cylindrical body 34, the longitudinal axis of which is parallel to the axis of rotation of the compressor 22. The cylindrical body 34 comprises a first end 36 proximal to the compressor 22, a second end 38 distal to the compressor, a plurality of serrations 40 and a plurality of holes 42.

The first end 36 is mounted to the compressor 22, and the second end 38 is closed by a wall 48 of the enclosure 30. The silencer 28 and the wall 48 may therefore be regarded as defining a chamber into which the airflow emitted by the compressor 22 enters.

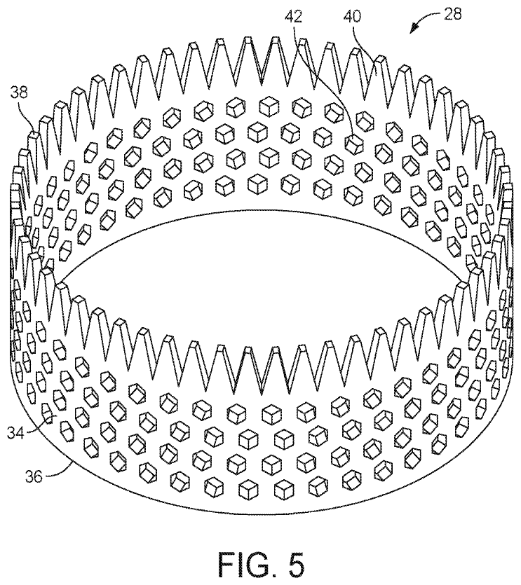

The serrations 40 are provided at the second end 38. The serrations 40 are provided around the circumference of the second end 38 and extend in the axial direction. In the example of FIG. 5, the serrations 40 have a triangular shape. However, in other examples, the serrations may have other shapes such as rectangular or curved.

The holes 42 of the silencer 28 are located around the circumference of the cylindrical body 34. In this example, the silencer 28 has four rows of holes 42 distributed longitudinally between the first end 36 and the second end 38. However, other examples may comprise a greater or lesser number of rows.

The enclosure 30 encloses compressor 22 and the silencer 28. However, in other examples the enclosure 30 may only enclose the silencer 28.

The enclosure 30 comprises a cylindrical side wall 46 closed at the top and the bottom by a top wall 44 and a bottom wall 48 respectively. The bottom wall 48 is the wall of the enclosure 30, discussed previously, which closes the second end 38 of the silencer 28.

The enclosure 30 comprises a plurality of inlet holes 50 and a plurality of outlet holes 52. The inlet holes 50 are located in the side wall 46 towards the top of the enclosure 30 and are for allowing the airflow to enter the enclosure 30. In this example, the inlet holes 50 are circular and are arranged in numerous rows along the side wall 46. However, other examples may use other shapes and arrangements for the inlet holes 50.

The outlet holes 52 are located in the side wall 46 towards the bottom of the enclosure 30 and are for allowing the airflow to exit the enclosure 30. Each outlet hole 52 of the enclosure 30 is circular in shape and is aligned with a respective hole 42 of the silencer 28, the benefits of which are explained below.

The seal 31 extends between and forms a seal with the side wall 46 of the enclosure 30 and the compressor 22. The seal 31 forms a seal with the enclosure 30 at a position between the inlet holes 50 and the outlet holes 52. The seal 31 therefore ensures that airflow is drawn into the compressor 22 via the inlet holes 50 in the enclosure 30 and is expelled via the outlet holes 52.

The acoustic foam 32 is located within the chamber defined by the silencer 28 and the bottom wall 44 of the enclosure 30. The acoustic foam 32 comprises an open-cell foam that permits airflow to flow through the foam.

In use, the compressor 22 draws an airflow into the enclosure 30 via the inlet holes 50. The airflow then passes through the compressor 22 and into the chamber occupied by the acoustic foam 32. The airflow moves through the acoustic foam 32 whereupon some of the noise generated by the compressor 22 is attenuated. The airflow then splits. A portion of the airflow passes between the serrations 40, and a further portion of the airflow passes through the holes 42 of the silencer 28. The airflow then re-joins and exits the enclosure 30 via the outlet holes 52.

As the airflow passes between the serrations 40, the serrations 40 generate streamwise vorticity in the airflow, which provides more mixing at the free shear layer and thereby reduces the noise generated by the moving airflow. Additionally, as the airflow passes through the holes 42 of the silencer 28, large eddies in the airflow are broken down, which reduces large scale turbulence and thereby also reduces the generated noise. Therefore, by comprising the silencer 28, the noise generated by the compressor 22 may be reduced whilst also achieving a relatively small reduction in the flow rate for the airflow. Reducing the noise generated by the compressor 22 may have several benefits, including improving the acoustic experience of a user of the vacuum cleaner 10 and aiding in compliance with noise-limit regulations. Moreover, noise reduction may be achieved without modification to the filter assembly 18. Thereby, the performance of the filter assembly 18 (e.g. washability and filter life) may not be impacted whilst also achieving reduced noise generation.

The generation of vorticity by the serrations 40 is dependent on the open area between the serrations 40, which is defined by the number and height of the serrations 40. In this particular example, the serrations 40 each have a height of 6 mm. However, serrations 40 having other heights may also be used. As the height of the serrations 40 increases, the gains in noise reduction may increase. However, as the height of the serrations 40 increases, the size of the compressor assembly 16 also increases, resulting in a less compact arrangement for the compressor assembly 16. A more compact arrangement may be desirable in applications for which space is a premium. For example, in handheld devices, such as the handheld vacuum cleaner 10 of FIGS. 1 and 2, a more compact arrangement may improve the ergonomics of the device. Conversely, as the height of the serrations 40 decreases, more of the airflow is forced through the holes 42 of the silencer 28, thereby reducing the contribution of the serrations 40 to the noise reduction. The inventors have observed that the gains in noise reduction are more modest at excessively great heights (say greater than around 10 mm). Similarly, the inventors have observed that for excessively short heights (say less than around 2 mm) the gains in noise reduction are also modest. Accordingly, the serrations 40 may have a height of at least 2 mm and no greater than 10 mm. This then provides a good balance between the competing needs of reducing the noise generated and providing a compact compressor assembly 16.

Each hole 42 of the silencer 28 is hexagonal in shape. The inventors have observed that holes with straight edges aid in reducing the noise generated. As a result, the noise generated may be further reduced without adversely reducing the flow rate of the airflow. In particular, a further reduction in noise may be achieved by virtue of the shape of the holes 42 without reducing the area of the holes 42. Equally, in other examples the holes 42 of the silencer 28 may have other polygonal shapes, such as pentagonal, square or triangular. However, having a hexagonal shape is beneficial in that holes of a given area, and having distinct straight edges, may be achieved in a relatively compact arrangement. In spite of the aforementioned advantages in having holes 42 that are polygonal in shape, the holes 42 may, in other examples, be circular or elliptical.

Each hole 42 of the silencer 28 has an area of 2 mm². However, other sizes of holes 42 may be used. As the areas of the holes 42 increases, the silencer 28 presents a smaller restriction to the airflow, and therefore a smaller reduction in the flow rate of the airflow may be observed. Conversely, as the areas of the holes 42 decreases, the amount of noise reduction provided by the silencer 28 is likely to increase. Therefore, a good balance between the competing needs of reducing noise and achieving a good flow rate may be achieved with holes 42 having an area of no less than 1.5 mm² and no greater than 7 mm².

The airflow exits the compressor 22 in an axial direction and is emitted from the silencer 28 (through the holes 42 and between the serrations 40) in a radial direction. As a result, a relatively short and compact silencer 28 may be employed that nevertheless has sufficient open area to deliver a desired flow rate.

As described above, each outlet hole 52 of the enclosure 30 is aligned with a respective hole 42 of the silencer 28. As a result, the overall restriction of the airflow by the holes 42,52 may therefore be reduced (for example, compared to holes which are not aligned), which may reduce the reduction in flow rate caused by the holes 42,52 of the enclosure 30 and/or silencer 28.

Each outlet hole 52 of the enclosure 30 has an area of 7 mm². As a result, a ratio of the area of each hole 42 of the silencer 28 to the area of the respective hole 52 of the enclosure 30 is around 0.3. The inventors have observed that as this ratio is decreased, the noise generated decreases. However, the restriction to the airflow presented by the silencer 28 and enclosure 30 increases. Therefore, a good balance between the competing needs of reducing the noise generated and achieving a good flow rate may be achieved by having a ratio of between 1.0 and 0.2, and more particularly 0.6 and 0.2.

Each outlet hole 52 of the enclosure 30 is circular in shape. Thereby, the outlet holes 52 of the enclosure 30 have a different shape to the holes 42 of the silencer 28. Equally, the outlet holes 52 of the enclosure 30 may have other shapes, for example elliptical, and still achieve noise reduction.

In the above example, the acoustic foam 32 is located within the chamber defined by the silencer 28 and the wall 44. Thereby the silencer 28 surrounds the acoustic foam 32 which may provide a relatively compact arrangement. The acoustic foam 32 acts to attenuate some of the noise generated by the moving airflow. However, the acoustic foam 32 also presents a restriction to the airflow. Accordingly, in other examples, the acoustic foam 32 may be omitted from the compressor assembly 16.

In the above example, the silencer 28 is mounted to the compressor 22 at the first end 36. This may reduce the noise generated by reducing the vibrations transferred from the compressor 22 to the silencer 28. By contrast, if the silencer 28 were mounted to the compressor 22 at the second end 38, additional structural vibrational noise may be generated at the serrations 40. Additionally, by mounting the compressor 22 at the first end 36 (as compared to mounting the compressor 22 at the second end 38 with the serrations 40) stress concentrations at the ends of the serrations 40 may be reduced, which may increase the operational life of the compressor assembly 16. However, it is conceivable that the silencer 28 could be mounted to the compressor 22 at the second end 38, i.e. at the ends of the serrations 40.

In the above example, the bottom wall 44 of the enclosure 30 is described as closing the second end 38 of the silencer 28. However, it is envisaged that other walls of the compressor assembly 16 may close the second end 38. For example, the silencer 28 may comprise a wall for closing the second end 38.

Although the compressor assembly 16 described above forms part of a vacuum cleaner 10, the compressor assembly 16 and/or the silencer 28 may be used in other devices for which an airflow moves through the device. By way of example, the compressor assembly 16 may form part of a fan assembly or a haircare appliance.

1. A compressor assembly comprising:
a compressor for generating an airflow through the compressor assembly; and
a silencer located downstream of the compressor, the silencer comprising:
a plurality of holes through which a portion of the airflow flows;
a first end proximal to the compressor;
a second end distal to the compressor; and
serrations provided at one of the first end and the second end and between which a further portion of the airflow flows.

2. The compressor assembly as claimed in claim 1, wherein each serration has a height of no less than 2 mm or no greater than 10 mm.

3. (canceled)

4. The compressor assembly as claimed in claim 1, wherein each hole is polygonal in shape.

5. The compressor assembly as claimed in claim 1, wherein each hole has an area of no greater than 7 mm² or no less than 1.5 mm².

6. (canceled)

7. The compressor assembly as claimed claim 1, wherein:
the compressor assembly comprises an enclosure for enclosing the silencer;
the enclosure comprises a plurality of holes through which the airflow flows; and
each hole of the silencer is aligned with a respective hole of the enclosure.

8. The compressor assembly as claimed in claim 7, wherein a ratio of an area of each hole of the silencer to an area of the respective hole of the enclosure is less than 1.0.

9. (canceled)

10. The compressor assembly as claimed claim 1, wherein the compressor assembly comprises an acoustic foam located downstream of the compressor and upstream of the silencer.

11. The compressor assembly as claimed in claim 10, wherein the silencer surrounds the acoustic foam.

12. The compressor assembly as claimed in claim 1, wherein:
the airflow is emitted from the compressor in an axial direction;
the silencer is cylindrical in shape; and
the airflow passes through the holes of the silencer and between the serrations in a radial direction.

13. The compressor assembly as claimed in claim 1, wherein the silencer is mounted to the compressor at the first end, and the serrations are provided at the second end.

14. A silencer for a compressor comprising:
a cylindrical body having a plurality of holes through which a portion of an airflow generated by the compressor flows; and
serrations provided at an end of the cylindrical body and between which a further portion of the airflow flows.

15. A compressor assembly comprising:
a compressor for generating an airflow through the compressor assembly;
a silencer located downstream of the compressor, the silencer comprising a plurality of holes through which at least a portion of the airflow flows; and
an enclosure located downstream of the silencer, the enclosure comprising a plurality of holes through which the airflow flows,
wherein:
each hole of the silencer is aligned with a respective hole of the enclosure; and
a ratio of an area of each hole of the silencer to an area of the respective hole of the enclosure is less than 1.0.

16. (canceled)

17. The compressor assembly as claimed in claim 15, wherein the holes of the silencer have a different shape to the holes of the enclosure.

18. The compressor assembly as claimed in claim 15, wherein the holes of the silencer are polygonal in shape, and the holes of the enclosure are circular or elliptical in shape.

19. The compressor assembly as claimed in claim 15, wherein the silencer comprises:
a first end proximal to the compressor;
a second end distal to the compressor; and
serrations provided at one of the first end and the second end and between which a further portion of the airflow flows.

20. The compressor assembly as claimed in claim 19, wherein each serration has a height of no less than 2 mm or no greater than 10 mm.

21. The compressor assembly as claimed in claim 15, wherein the compressor assembly comprises an acoustic foam located downstream of the compressor and upstream of the silencer, and the silencer surrounds the acoustic foam.

22. (canceled)

23. The compressor assembly as claimed in claim 15, wherein:
the airflow is emitted from the compressor in an axial direction;
the silencer is cylindrical in shape; and
the airflow passes through the holes of the silencer in a radial direction.

24. The compressor assembly as claimed in claim 19, wherein the silencer is mounted to the compressor at the first end, and the serrations are provided at the second end.

25. A vacuum cleaner comprising a compressor assembly or silencer according to claim 1.
